(19) United States
(12) Patent Application Publication
(10) Pub. No.: US 2026/0068998 A1
(43) Pub. Date: Mar. 12, 2026

(54) Strap Tensioner and Tension Indicator

(71) Applicant: CARE4FUTURES LIMITED, Belbroughton (GB)

(72) Inventor: Philip STAUNTON, Cheltenham (GB)

(21) Appl. No.: 19/107,420

(22) PCT Filed: Sep. 1, 2023
(86) PCT No.: PCT/EP2023/073988

§ 371 Date: Feb. 27, 2025

(30) Foreign Application Priority Data
Sep. 1, 2022 (GB) 2212753.4

(51) Int. Cl. A44B 11/06

(52) U.S. Cl. CPC A44B 11/065

(57) ABSTRACT

A strap tensioning assembly having a casing and a reel or a pair of reels. A dial rotates the reels to reel in a tension member on each reel. A first torque limiting clutch is provided between the first reel and the dial, such that a tension in the first tension member is limited.

### CROSS-REFERENCE TO RELATED APPLICATIONS

This application is a national stage of International Application No. PCT/EP2023/073988, filed on Sep. 1, 2023, which claims priority to GB Patent Application No. 2212753.4, filed on Sep. 1, 2022. The disclosures of both of the aforementioned applications are hereby incorporated by reference in their entireties.

### TECHNICAL FIELD

The present application is concerned with a strap tensioner, and a tension indicator. More specifically, the present application is concerned with a strap tensioner utilising a ratchet and release mechanism, and an in-line tension indicator that can provide an ongoing and persistent indication of the degree of tension in a strap.

By ‘strap’ we mean a flexible elongate structure that is capable of holding a tensile load. Straps may be extensible or inextensible. Straps may be constructed from many different materials, for example a close-woven inextensible, flat fabric material such as webbing.

The present disclosure also has many applications, ranging from occupant harnesses to goods harnesses (such as straps for securing goods in transport) and straps for safety nets e.g., in motorsport. The present disclosure is also well suited to use in stretchers—i.e. to tension strapping around a human or animal patient. The disclosure also relates to straps for rucksacks and other types of bags and human-carried equipment, particularly equipment carried on a user's back with shoulder and belt straps. The invention can be applied to the straps that secure the equipment to the user, and also to straps that secure equipment to a frame for e.g. a rucksack.

### BACKGROUND

A strap may refer to a flexible elongate structure. Some straps are capable of holding a tensile load. Straps may be extensible or inextensible. Straps may be constructed from a variety of materials, such as leather or other flexible materials.

### BRIEF SUMMARY

According to a first aspect of the disclosure there is provided a strap tensioning assembly comprising:
a casing
a reel configured to wind a first tension member into the casing upon rotation thereof;
a dial connected to the reel such that rotation of the dial rotates the first and second reels;
a first torque limiting clutch between the first reel and the dial, such that a tension in the first tension member is limited.

In some embodiments, the torque limiting clutch comprises a deformable friction member between a hub or drum, driven by the dial, and the reel. In various embodiments, the deformable friction member is an elastomeric ring in contact with both the hub and the reel.

In some embodiments, the assembly comprises at least one one-way clutch between the reel and the housing, such that rotation of the reel and the housing is enabled in a first direction but prohibited in a second, opposite, direction.

In some embodiments, the dial is moveable along its axis of rotation such that movement of the dial away from the housing causes the one-way clutch mechanism to disengage to allow rotation of the reel in the second direction.

In some embodiments, the assembly comprises a third, positive, clutch between the dial and the hub, such that movement of the dial away from the housing disengages the third clutch to decouple the dial from the hub. By “positive” clutch we mean a non-slip clutch having two conditions (engaged where all torque is transferred and disengaged where no torque is transferred). In various embodiments, the third clutch comprises two interlocking sets of teeth on the dial and the hub respectively. In many embodiments, movement of the dial away from the housing causes the third clutch to disengage before the second clutch.

The disclosure also provides an assembly of a mounting plate and an item to be mounted, the assembly comprising a strap holding the item to be mounted against the mounting plate, wherein tension in the strap causes a bending moment to be applied to the mounting plate, and wherein the assembly comprises a strap tensioning assembly according to any preceding claim configured to thereby limit the tension in the strap.

The item to be mounted may be a tank, for example part of a breathing apparatus to be secured to a user's back. For example, it may be a firefighter breathing apparatus.

According to a second aspect of the present disclosure there is provided a strap tensioning assembly comprising:
a casing;
a first reel configured to wind a first tension member into the casing upon rotation thereof;
a second reel configured to wind a second tension member into the casing upon rotation thereof;
a dial connected to the first and second reels such that rotation of the dial rotates the first and second reels;
a first torque limiting clutch between the first reel and the dial, such that a tension in the first tension member is limited.

In various embodiments, the provision of a torque limiting clutch on one or both of the reels allows the strap tension to be adjusted to different levels, whilst having both straps tensioned by the same action of rotating the dial. This is beneficial for straps that may need to be adjusted to different lengths with the same tension (such as on stretchers) but also applications where one strap needs to be tighter than the other (such as on backpacks).

In some embodiments, the assembly comprises a second torque limiting clutch between the second reel and the dial, such that a tension in the second tension member is limited.

In some embodiments, the first and second torque limiting clutches are configured to slip at different tensions in the first and second tension members respectively.

In some embodiments, the second reel has a direct drive from the dial with no torque limitation.

In some embodiments, the torque limiting clutch or clutches is defined between a hub member and the or each reel, the hub member being directly connected to the dial.

In some embodiments, the torque limiting clutch or clutches comprises a deformable friction member between the or each hub and the or each respective reel.

In some embodiments, the deformable friction member is an elastomeric ring in contact with both the or each hub and the or each respective reel.

In some embodiments, the reels are concentric.

In some embodiments, the assembly comprises at least one one-way clutch between at least one of the first and second reels and the housing, such that rotation of the respective reel and the housing is enabled in a first direction but prohibited in a second, opposite, direction.

In some embodiments, the dial is moveable along its axis of rotation such that movement of the dial away from the housing causes the one-way clutch mechanism to disengage to allow rotation of the reel in the second direction.

In some embodiments, the assembly comprises a third, positive, clutch between the dial and the hub, such that movement of the dial away from the housing disengages the third clutch to decouple the dial from the hub. By “positive” clutch we mean a non-slip clutch having two conditions (engaged where all torque is transferred and disengaged where no torque is transferred). In various embodiments, the third clutch comprises two interlocking sets of teeth on the dial and the hub respectively. In many embodiments, movement of the dial away from the housing causes the third clutch to disengage before the second clutch.

According to a third aspect of the disclosure there is provided a strap tensioning assembly comprising:
a casing;
a reel configured to wind a tension member into the casing upon rotation thereof about a winding axis in a first direction, the reel engaged with the casing via a one-way clutch mechanism;
a dial connected to the reel such that rotation of the dial rotates the reel;
wherein the dial is moveable along the winding axis such that movement of the dial away from the housing causes the one-way clutch mechanism to disengage to allow rotation of the reel in a second direction, opposite the first direction.

In various embodiments, this type of mechanism is “pull to release”, meaning that the single action of lifting the reel from the casing both unlocks the ratchet mechanism and pulls the tension member to unwind the (now unlocked) reel.

In some embodiments, the one-way clutch mechanism is a ratchet.

In some embodiments, the reel is connected to the dial via a torque limiting clutch to limit the amount of torque transmitted from the dial to the reel.

In some embodiments, a sub in the form of a drum a the load path between the dial and the reel, in which the clutch is provided between the drum and the reel.

In some embodiments, the clutch comprises an o-ring between the drum and reel.

In some embodiments, there is provided a further reel configured to wind a further tension member into the casing upon rotation thereof about the winding axis, the further reel engaged with the casing via a one-way clutch mechanism, and rotation of the dial rotates the further reel.

In some embodiments, the further reel is connected to the dial via a further torque limiting clutch to limit the amount of torque transmitted from the dial to the further reel.

In some embodiments, the torque limiting clutch of the reel is set at a different tension to the further torque limiting clutch of the further reel.

In some embodiments, the dial comprises an overhanging portion configured to allow a user's fingers to grip the dial for lifting away from the casing.

In some embodiments, there is provided a dial locking mechanism configured to inhibit lifting of the dial from the casing.

In some embodiments, the dial locking mechanism comprises a button that requires depression to unlock the dial.

In some embodiments, the dial is biased towards the casing.

In one embodiment, more than one tension member is wound around the or each reel to tighten more than one strap simultaneously.

According to a fourth aspect there is provided a tension indicator for indication of tension between two portions of a flexible member, comprising:
a housing;
a carriage slideable relative to the housing along a first axis;
wherein:
   the housing is connected to a first mounting portion for attachment of a first portion of a flexible member; and,
   the carriage is connection to a second mounting portion for attachment of a second portion of a flexible member;
   such that tension applied between the first and second portions of the strap is transmitted through the tension indicator in a tension direction along a tension axis;
a resilient element disposed between the carriage and the housing to bias the carriage in a direction opposite to the tension direction along the tension axis; and,
an indicator member configured to move from a first position to a second position in a direction normal to the tension axis upon movement of the carriage in the tension direction to thereby indicate the applied tension.

In various embodiments, the present disclosure provides a clearly visible and persistent indication of tension in the strap, and is mechanically robust.

In some embodiments, the indicator member may be mounted to the carriage, and bears against a surface of the housing such that relative movement of the carriage and housing causes relative movement between the carriage and the indicator member.

In some embodiments, the indicator member is resiliently outwardly biased from the carriage.

In some embodiments, the indicator member is angled between 0 and 90 degrees to the tension axis in at least one position thereof.

In some embodiments, there is provided a first and a second indicator member, each member configured to move from a first position to a second position in a direction normal to the tension axis upon movement of the carriage in the tension direction to thereby indicate the applied tension.

In some embodiments, the indicator members are positioned on opposite sides of the carriage.

In some embodiments, the indicator members are oppositely resiliently biased relative to the carriage.

In some embodiments, the tension members spread apart as the carriage moves out of the housing along the tension axis.

According to a fifth aspect of the disclosure there is provided a tension indicator for indication of tension between two portions of a flexible member, comprising:
a housing;
one or more contact members forming a non-straight path within the housing;
a section of flexible member attached to the housing at a first end, and comprising a visual indicator applied thereto;
wherein:
the flexible member passes along the non-straight path through the one or more contact members in a first, rest condition;
upon the application of tension, the flexible member applies a force to the one or more contact members to at least partially straighten the path by moving and/or deforming the one or more contact members, thereby reducing the amount of flexible member within the housing and changing the position of the visual indicator relative to the housing; and,
upon release of the tension, the one or more contact members provides a resilient force onto the flexible member to restore the non-straight path within the housing.

In some embodiments, the one or more contact members comprises a plurality of contact members, with at least one contact member on either side of the flexible member.

In some embodiments, the plurality of contact members comprises a plurality of at least partially interdigitated contact members on either side of the flexible member.

In some embodiments, the plurality of contact members are resiliently mounted to the housing.

In some embodiments, the plurality of contact members are resiliently deformable.

In some embodiments, the plurality of contact members are curved, having convex contact regions with the flexible member.

In some embodiments, the flexible member is planar.

In some embodiments, the flexible member is webbing.

In some embodiments, the flexible member is inextensible.

In some embodiments, the disclosure also provide a flexible member tensioning assembly comprising:
a tension indicator according to the first or second aspect; and,
a tensioner attached to the housing, the tensioner configured to apply tension to the flexible member.

In some embodiments, the tensioner and the tension indicator are mutually detachable.

In some embodiments, one of the tensioner and tension indicator comprises a first member engaged with a releasable formation on the other of the tensioner and tension indicator.

In some embodiments, the tensioner comprises a ratchet.

In some embodiments, the assembly comprises a first section of flexible material attached to the tensioner, and a second section of flexible material attached to the tension indicator, such that the tension indicator is part of the tension load path at all times.

### BRIEF DESCRIPTION OF DRAWINGS

An embodiment of the present disclosure will now be described with reference to the following figure in which:

FIG. 1 is a plan view of a first strap tension indicator apparatus according to the present disclosure;

FIG. 2 is a plan view of the strap tension indicator apparatus of FIG. 1;

FIG. 3 is a side view of the strap tension indicator apparatus of FIG. 1;

FIG. 4 is a side section view of the strap tension indicator apparatus of FIG. 1;

FIG. 5 is a plan section view of the strap tension indicator apparatus of FIG. 1;

FIG. 6a is an upper perspective view of a part of the tension indicator apparatus of FIG. 1;

FIG. 6b is an upper perspective section view of a part of the tension indicator apparatus of FIG. 1 along plane B of FIG. 6a;

FIG. 7a is a lower perspective view of a part of the tension indicator apparatus of FIG. 1;

FIG. 7b is a lower perspective section view of a part of the tension indicator apparatus of FIG. 1 along plane B of FIG. 7a;

FIG. 8 is a perspective side section view of a part of the tension indicator apparatus of FIG. 1;

FIG. 9 is a perspective view of a second strap tension indicator apparatus according to the present disclosure;

FIG. 10 is a plan view of the apparatus of FIG. 9;

FIGS. 11a to 11d are side section views of the apparatus of FIG. 9;

FIG. 12 is a plan view of an application of the present disclosure;

FIG. 13 is a perspective view of a first tensioner according to the present disclosure;

FIG. 14 is a plan view of the tensioner of FIG. 13;

FIG. 15 is a perspective view of a component of the tensioner of FIG. 13;

FIG. 16a is a perspective view of a component of the tensioner of FIG. 13;

FIG. 16b is a perspective section view of the component of FIG. 16a;

FIGS. 17 and 18 are exploded views of subassemblies of the tensioner of FIG. 13;

FIG. 19 is a perspective view of a component of the tensioner of FIG. 13;

FIG. 20 is a perspective section view of the tensioner of FIG. 13;

FIG. 20a is a perspective view of the tensioner of FIG. 13 utilised on a stretcher;

FIG. 21 is a view of a second tensioner according to the present disclosure;

FIGS. 22 & 23 are exploded perspective views of the tensioner of FIG. 21;

FIGS. 24 & 25 are perspective view of an application for the tensioner of FIG. 21;

FIG. 26 is a perspective view of a third tensioner in accordance with the present disclosure;

FIG. 27 is an exploded view of a fourth tension in accordance with the present disclosure;

FIG. 28 is a perspective view of an application for the fourth tensioner; and,

FIG. 29 is a plan view of the application of FIG. 28.

### DESCRIPTION OF THE FIRST EMBODIMENT

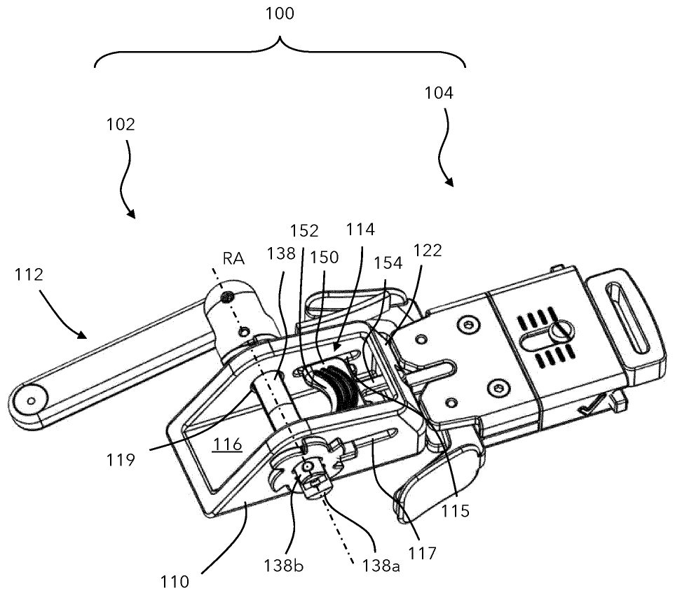

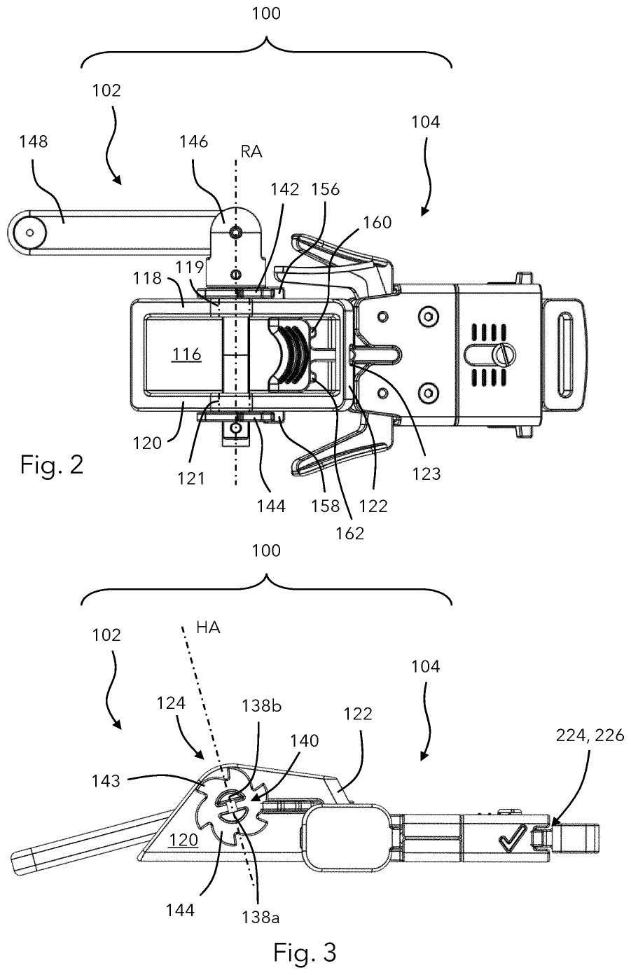

A strap tensioning assembly 100 is shown in FIGS. 1 to 8.

### Configuration

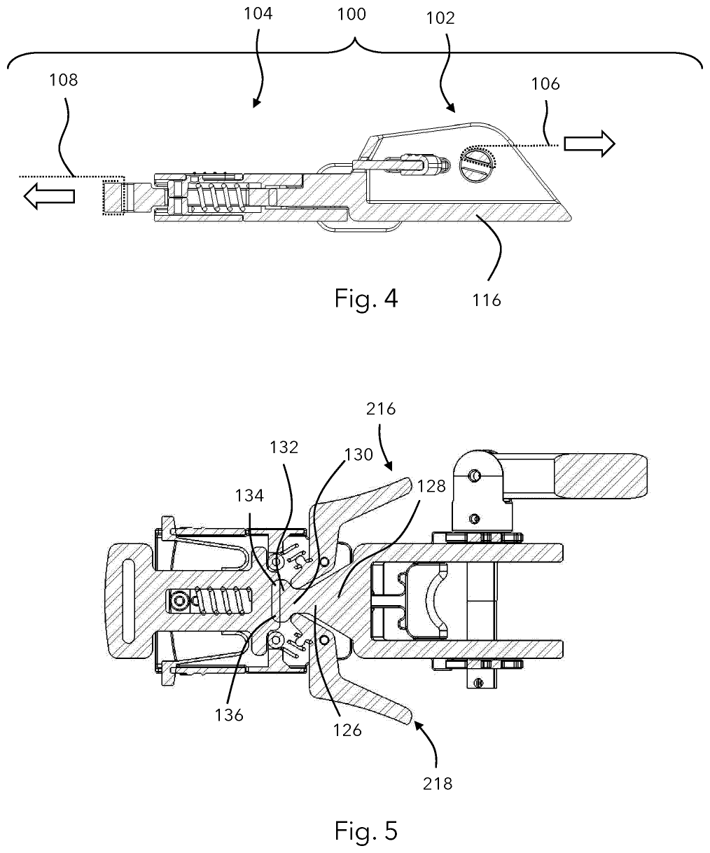

Referring to FIGS. 1 to 8, a strap tensioning assembly 100 comprises a tensioner 102 and a tension indicator assembly 104. The assembly 100 is configured to produce a tension between a first and second section of strap 106, 108 respectively (FIG. 4).

### Configuration of the Tensioner 102

The tensioner 102 comprises a tensioner body 110, a ratchet assembly 112 and a pawl 114. The tensioner body 110 comprises a generally rectangular base 116, first and second sidewalls 118, 120 extending along the longer sides of the base 116, and an endwall 122. Referring to FIG. 3, the sidewalls 118, 120 are generally trapezium shaped, tapering inwardly from the base 116. Each sidewall defines an opening 119, 121, which openings are aligned along a ratchet axis RA. Each sidewall defines an elongate slot 115, 117. The endwall 122 is raked inwardly and defines an opening 123. The free edges of the sidewalls 118, 120 and the base 116 define an opening 124 into an internal volume of the body 110.

Extending from the endwall 122 there is provided a locking arm 126. The locking arm 126 is shown in the section view of FIG. 5 and has a generally triangular base 128 tapering inwardly towards a neck 130. A head 132 is disposed proximate the neck, formed from two outwardly extending ears 134, 136.

The ratchet assembly 112 comprises a shaft 138 comprising two semi-cylindrical half-shafts 138a, 138b having a channel 140 therebetween. The shaft is centred on the ratchet axis RA as will be described below. The shaft 138 has a first ratchet wheel 142 attached to a first end thereof, and a second ratchet wheel 144 attached to a second end thereof. Both ratchet wheels define teeth 143. Outboard of the first wheel 142 there is provided a handle base 146 to which a handle 148 is attached to pivot about a handle axis HA, perpendicular to the ratchet axis RA.

The pawl 114 comprises a generally rectangular pawl body 150 having a curved recess 152 defined on one long side. On the opposite long side there is provided a guide finger 154. Two spring retaining tabs 160, 162 are provided either side of, and spaced apart from, the finger 154. A pair of opposed pawl tabs 156, 158 extend from either respective short side.

### Assembly of the Tensioner

The tensioner is assembled by mounting the ratchet assembly 112 in the body 110 by mounting the shaft 138 for rotation about the ratchet axis RA in the openings 119, 121. The pawl 114 is mounted in sliding engagement in the body 110 with the pawl tabs engaging with, and extending outwardly from, the slots 115, 117. The finger 154 is engaged with the opening 123 in the endwall. In use, a resilient element (specifically a compression spring) is mounted between the pawl 114 and the endwall 122 such that the pawl 114 is urged towards the ratchet assembly 112. In this way, the tabs 156, 158 are urged into engagement with the respective wheels 142, 144, and more specifically the teeth 143.

In use, the handle 148 can be rotated to rotate the shaft 138 about the axis RA. Rotation in a clockwise direction (per FIG. 3) is permitted as the pawl rides over the ratchet. Rotation in a counter clockwise direction is not permitted unless the pawl is disengaged by a user.

### Configuration of the Tension Indicator Assembly 104

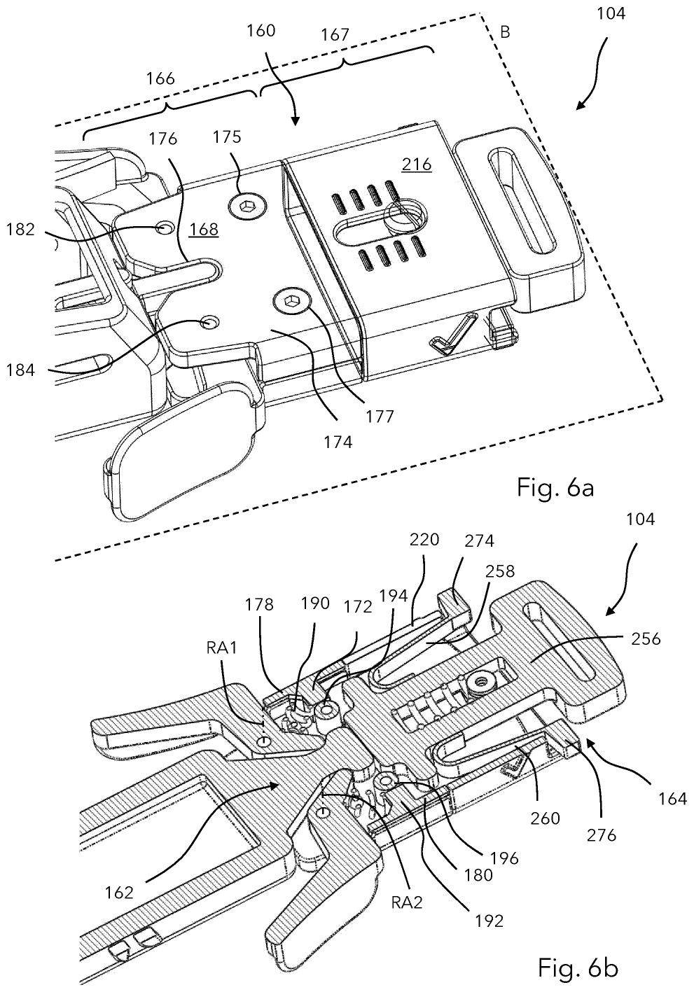

Referring to FIGS. 6a to 8, the tension indicator assembly 104 comprises a housing 160, a release mechanism 162 and an indicator 164.

### Housing 160

The housing 160 comprises a first housing section 166 and a second housing section 167.

The first housing section 166 has an upper part 168 and a lower part 170, both of which are concave defining a cavity 172.

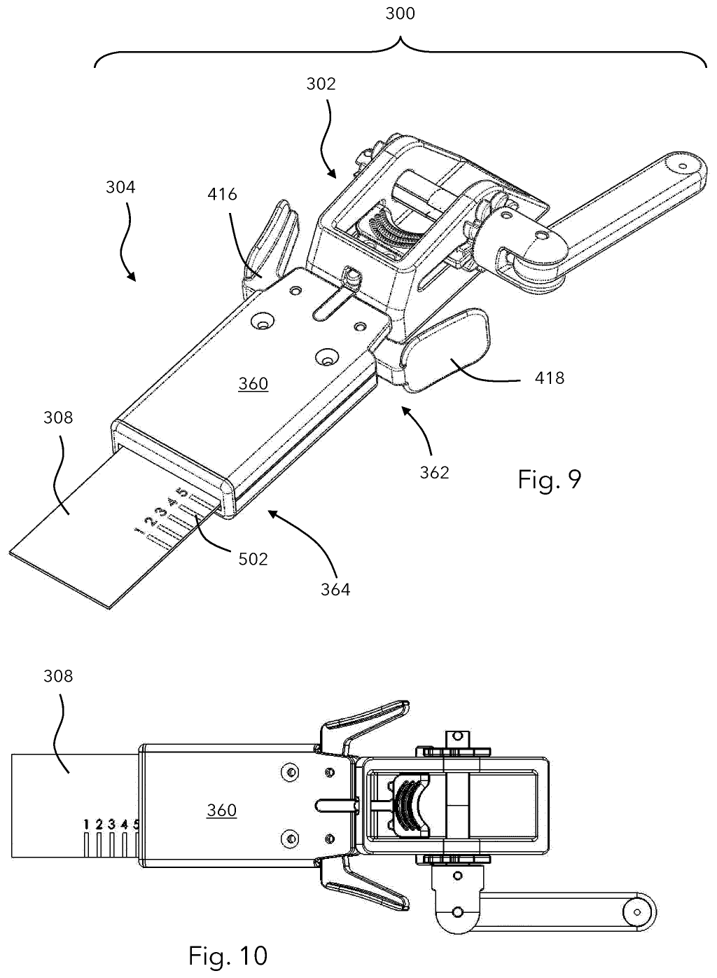

Referring to FIGS. 6a and 6b, the upper part 168 comprises a primary wall 174 having a notch 176 defined therein at a first edge. At a second edge, opposite the first, there is provided an elongate leg 244 (FIG. 9) defining a first boss 246 and a second boss 248 projecting opposite the first. The leg 244 is connected to the primary wall 174 by a shoulder 250.

Sidewalls 178, 180 are provided projecting from opposite edges of the primary wall, normal to the primary wall. The sidewalls extend partway along each edge of the primary wall 174. The primary wall 174 defines a pair of fastener apertures 182, 184 and a pair of pivot shaft openings 186, 188.

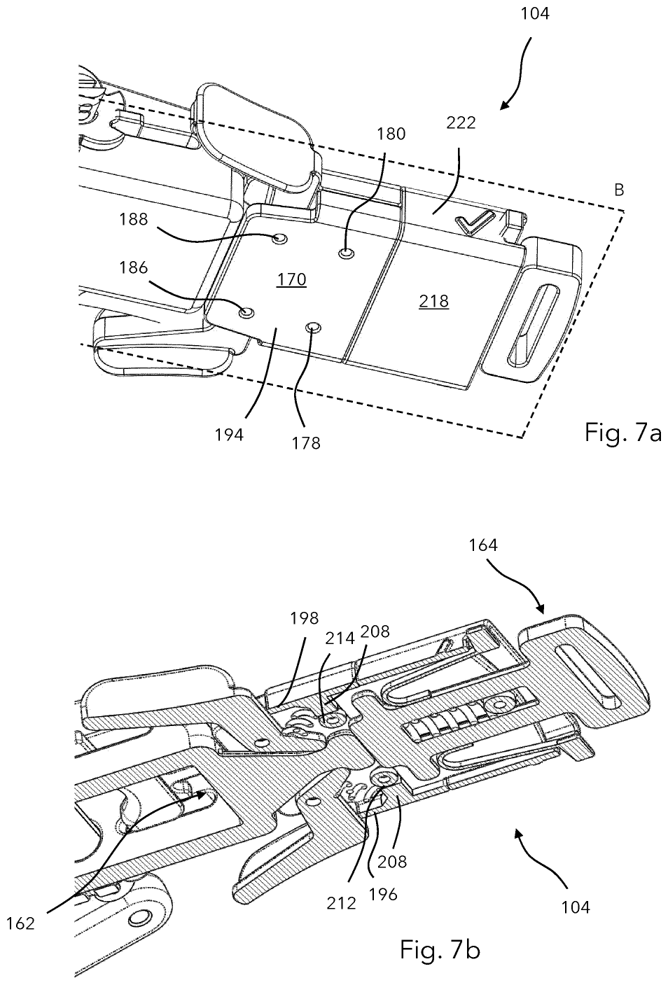

Projecting inwardly from each sidewall 178, 180 there is provided a respective shoulder 190, 192 (FIG. 7b).

A pair of fastener apertures 175, 177 are provided in the upper part 168 and a pair 178, 180 in the lower part 170. A pair of pivot shaft openings 182, 184 are provided in the upper part 168, and a pair of pivot shaft openings 186, 188 in the lower part 170.

Hollow shafts 194, 196 project upwardly from the primary wall 174, aligned with fastener apertures 175, 177.

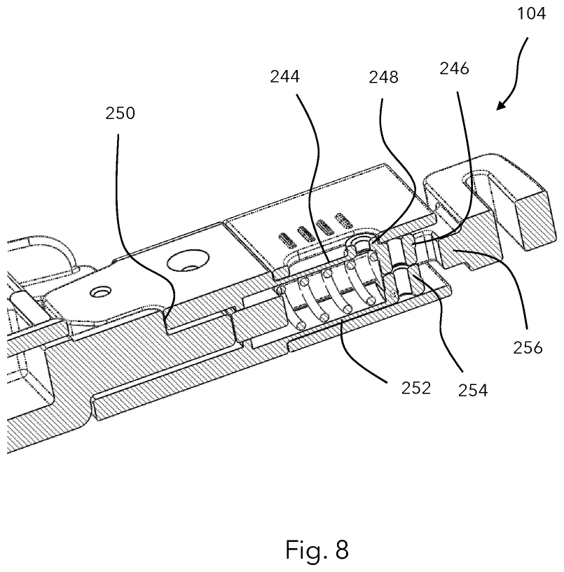

Referring to FIGS. 7a and 7b, the lower part 170 comprises a primary wall 194. Ona first edge there is provided an elongate leg 252 (FIG. 8) defining a boss 254. The leg 252 is connected to the primary wall 194 by a shoulder 256.

Sidewalls 196, 198 are provided projecting from opposite edges of the primary wall, normal to the primary wall. The sidewalls extend partway along each edge of the primary wall 194. The primary wall 194 defines a pair of fastener apertures 200, 202 and a pair of pivot shaft openings 204, 206.

Projecting inwardly from each sidewall 196, 198 there is provided a respective shoulder 208, 210 (FIG. 7b).

Hollow shafts 212, 214 project upwardly from the primary wall 194, aligned with the fastener apertures 178, 180.

The second housing section 167 is generally tubular having a rectangular cross section, defining an upper wall 216, a lower wall 218 and two sidewalls 220, 222. The sidewalls 220, 222 each have a notch 224, 226 defined in one end (FIG. 3).

### Release Mechanism 162

The release mechanism 162 comprises a first release arm 216, a second release arm 218, a first shaft 220 and a second shaft 222. The arms 216, 218 are identical, mirror images of each other. Each arm 216 comprises a respective contact portion 224, 226 which is connected to a central portion 228, 230 which in turn is connected to a finger 232, 234. The central portions 228, 230 each have a respective pivot shaft opening 236, 238.

Respective spring abutments 240, 242 are provided on each of the fingers 232, 234.

### Indicator 164

The indicator 164 comprises a carriage 256, a first wing 258 and a second wing 260.

The carriage 256 comprises a rectangular head 262 having a head slot 264 defined therein. Extending from the head 262 there is provided a neck 266 having a neck slot 268 being normal to the head slot 264. At the end of the neck 266 there are provided two tabs 270, 272.

The first and second wings 258, 260 are identical mirror images of each other. Each wing 258, 260 comprises a tab 274, 276 connected to a U-shaped resilient member 278, 280 having a long arm 282, 284 and a short arm 286, 288.

### Assembly of the Tension Indicator Assembly 104

The arms 216, 218 of the release mechanism 162 are installed in the first housing section by passing pivot shafts 220, 222 between the openings 186, 188, 204, 206 in the upper part 168 and lower part 170. The pivot shafts 220, 222 also pass through the openings 236, 238 to allow pivotable movement of the arms 216, 218 about release arm axes RA1, RA2.

The wings 258, 260 are attached to the carriage 256 by mounting the short arms 286, 288 to opposite sides of the neck 266. The wings 258, 260 therefore project outwardly from the carriage 256.

The carriage 256 is mounted for sliding engagement relative to the housing 160 by engaging the bosses 246, 254 into the neck slot 268. This provides sliding movement of the carriage 256 relative to the housing 160. A compressive resilient element (not shown) is positioned in the neck slot 268 between the aligned bosses 246, 254 and the inner end of the slot such that the carriage 256 is biased inwardly into the housing, to the position shown in FIG. 7b. At the extreme inward (untensioned) position the tabs 270, 272 abut the shafts 194, 196 which serve as a stop.

In the inward position the wings 258, 260 are lightly biased against the interior sidewalls 220, 222of the second housing section 167 by their own inherent resilient mechanical characteristics.

### Assembly of the Apparatus 100

The tensioner 102 and tension indicator assembly 104 can be connected by engaging the locking arm 126 into the housing 160 such that the head 132, and in particular the ears 134, 136 push the release arms 216, 218 apart. Once the head 132 passes the arms 216, 218 they resile back into position to lock the tensioner into position relative to the tension indicator assembly. Fundamentally, this allows tensile force to be transmitted between the tensioner and the tension indicator assembly.

In order to separate the two components, the contact portions 224, 226 can be moved inwardly towards the housing 160 which moves the fingers 232, 234 apart to allow the tensioner to be released.

### Use of the Apparatus 100

In use, a first section of strap in the form of webbing 106 is attached to the ratchet assembly 112 such that rotation of the handle 148 reels in the webbing 106. A second section of strap in the form of webbing 108 is attached through the head slot 264 of the carriage 256.

By tensioning the strap, a tensile force is transmitted through the apparatus 100. The webbing 106 is held in position by the engagement of the pawl. Increased tension starts to compress the compression spring in the tensioner indicator assembly. This moves the carriage 256 outwardly relative to the housing 160. This movement, in turn, allows the wings 258, 260 to move outwardly from the carriage 256 as it emerges from the housing. This serves as indication of the tension in the strap.

The wings 258, 260 are coloured differently to the housing (for example a portion may be coloured green) to display to the user that the strap is tensioned sufficiently. It will be noted that the tension indication is persistent—i.e. always present. Therefore, if there is a reduction in tension, this can be seen without undertaking a specific check.

### Description of the Second Embodiment

A second strap tensioning assembly 300 is shown in FIGS. 9 to 11d.

### Configuration

The assembly 300 is similar to the assembly 100 inasmuch as it comprises a tensioner 302 and a tension indicator assembly 304. The tensioner 302 is identical to that of the assembly 100 and as such will not be described in detail here.

### Configuration of the Tension Indicator Assembly 304

The tension indicator assembly 304 comprises a housing 360, a release mechanism 362 and an indicator 364.

### Release Mechanism 362

The release mechanism 362 comprises has two release arms 416, 418, which release the tensioner 302 from the indicator assembly in the same way as for the assembly 100. As such the mechanism will not be described in detail.

### Indicator 364

The indicator 364 comprises a web anchor 500 to which a portion of webbing 308 is attached. The webbing portion 308 comprises tension indicating markers 502.

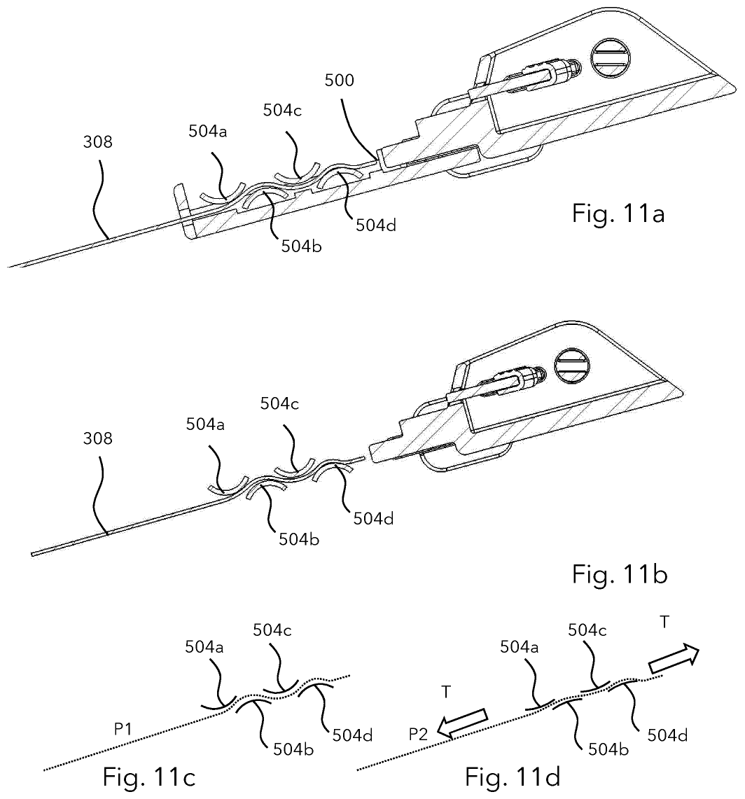

The indicator 364 further defines a plurality of resiliently deformable U-shaped members 504a-504d. The members 504a and 504c are positioned on a first side of the webbing 308, and the members 504b and 504d on a second side. The members 504a-504d are arranged such that they partially interdigitate to form a tortuous (non-straight) path P1 (FIG. 11c). When tension T is applied to the webbing 308 the tendency is for the webbing to straighten—i.e., to apply a planar outwards force to the members 504a-504c to produce a straighter path P2 (FIG. 11d). As a result, the length of webbing 308 within the housing 360 decreases with applied tension, making more of the indicator markers 502 visible. In this way, tension can be determined by the position of the markers 502 adjacent the end of the housing 360.

When tension is released, the members 504-504d resile to their rest shape, and the path of the webbing 308 reverts to PI (i.e., the webbing is drawn back into the housing 360).

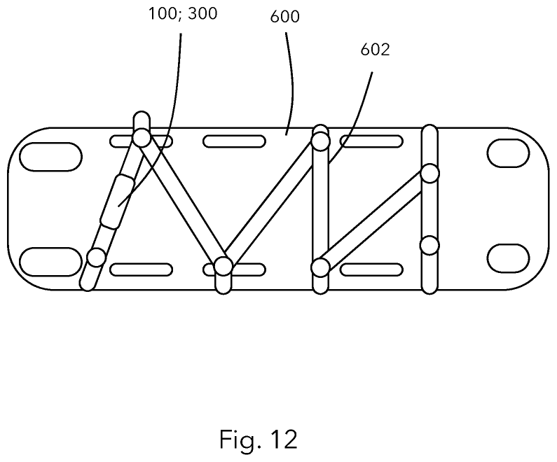

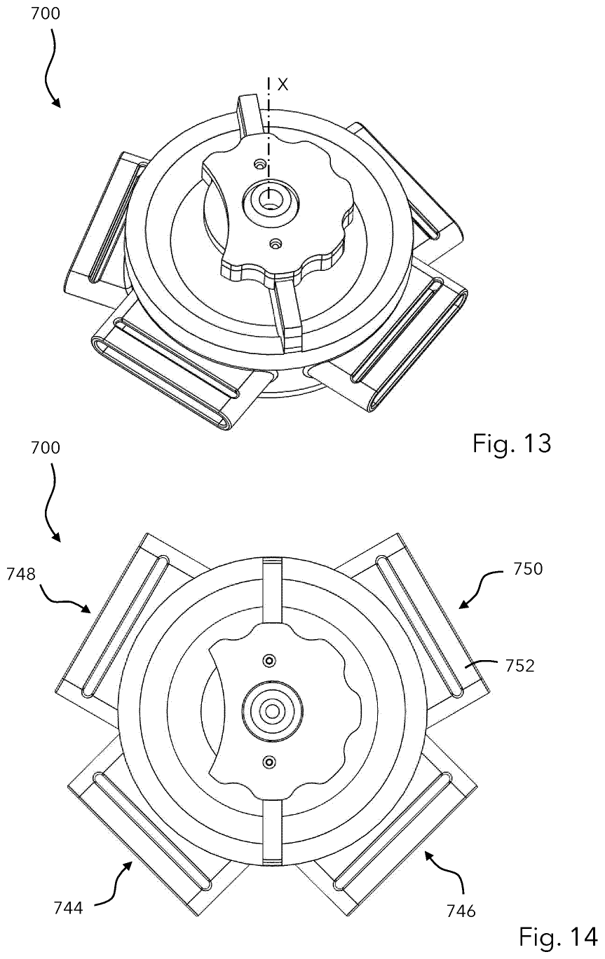

Referring to FIG. 12, an application of the present disclosure is shown, In this application, a stretcher 600 has a strapping system 602 incorporating the assembly (100 or 300) of the present disclosure. As well as being able to easily tighten the straps to a desired level that will secure, but not harm, the patient, the present disclosure also offers easy and quick release to patient transfer to a bed or gurney.

### Description of the Third Embodiment

A third strap tensioning assembly 700 is shown in FIGS. 13 to 20a. It comprises a primary axis X.

### Configuration

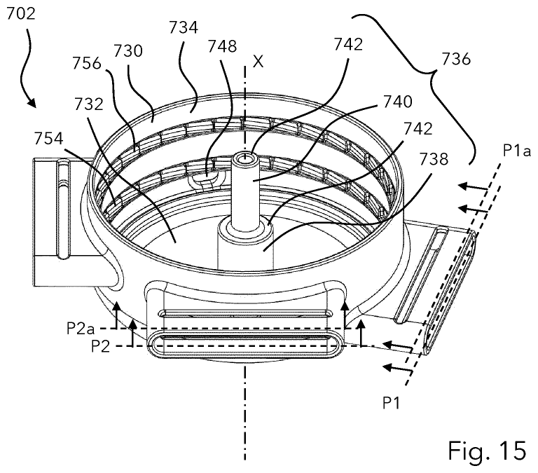

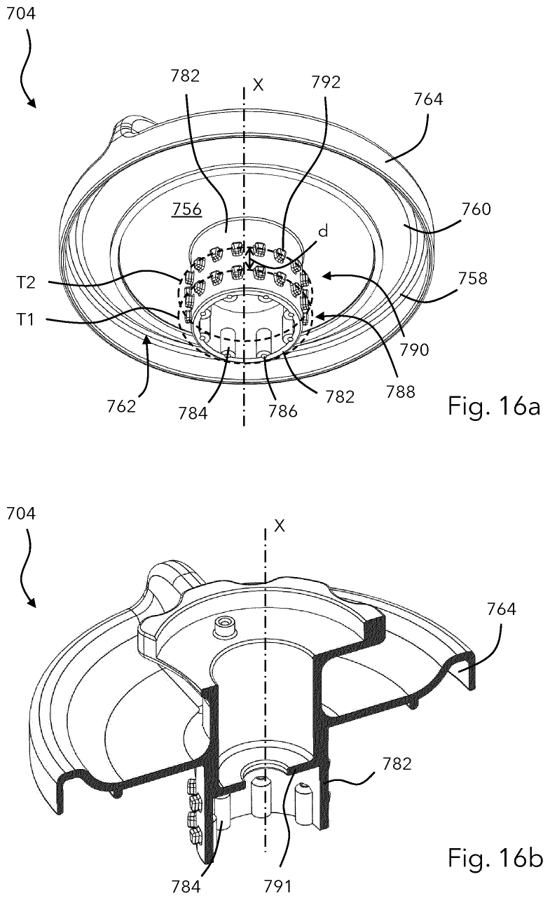

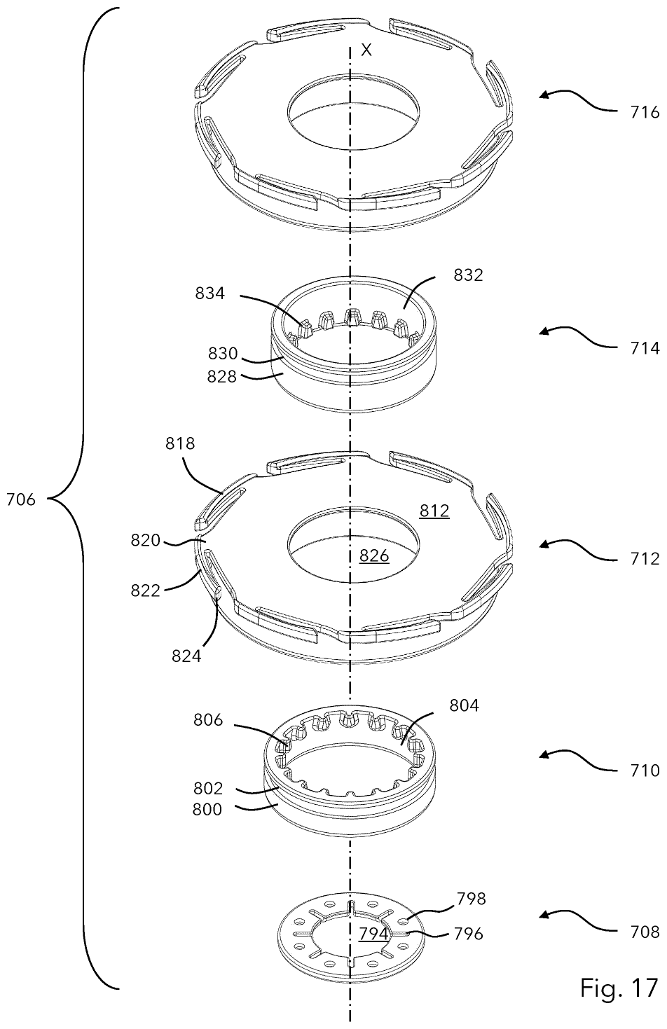

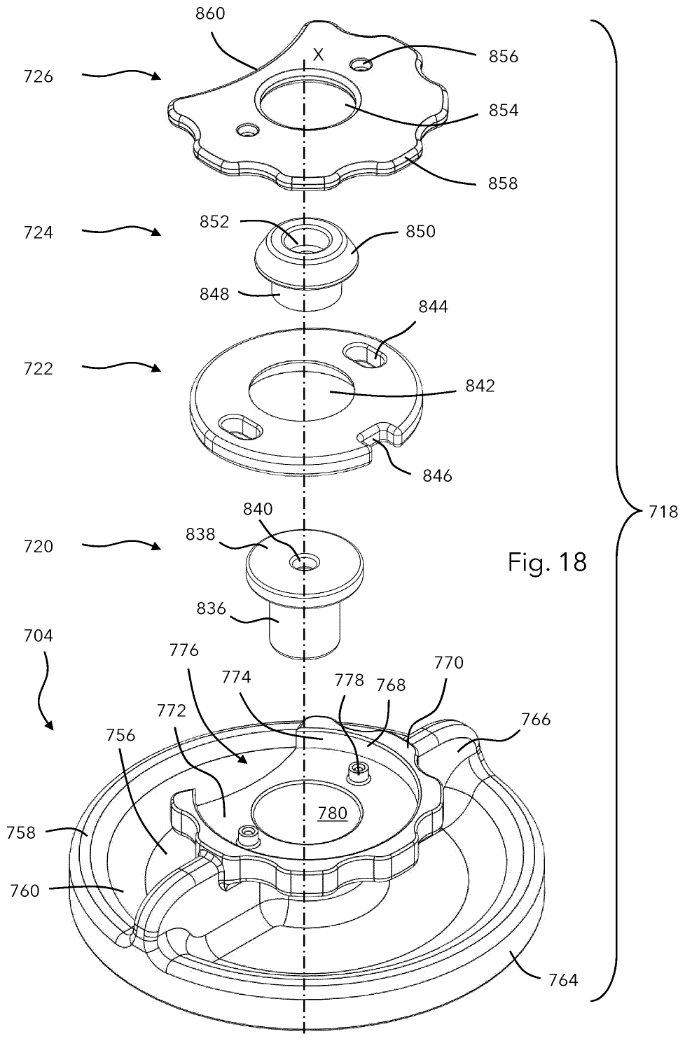

The assembly comprises:
A casing 702 (FIG. 15);
A dial 704 (FIGS. 16a, 16b);
A reel sub-assembly 706 (FIG. 17) comprising:
   A first washer 708;
   A first drum 710;
   A first reel 712;
   A second drum 714;
   A second reel 716;
An actuation sub-assembly 718 (FIG. 18) comprising:
   The dial 704;
   A washer 720;
   A button 722;
   A reel lead 724; and,
   A top cover 726.

### Casing 702

Referring to FIGS. 13 to 15, the casing 702 comprises a cylindrical body 730 having a closed endwall 732 and a cylindrical sidewall 734.

A central hub shaft 736 is provided extending from the endwall 732 along the axis X, and extends past the upper edge of the sidewall. The shaft 736 has a first portion 738 and a second portion 740 ending in a free end 742. The first portion 738 is higher in diameter than the second portion 740, and as such a step or shoulder 742 is provided therebetween.

Four ports 744, 746, 748, 750 are provided in the sidewall. The ports are generally elongate (in a circumferential direction) and have respective shrouds 752 extending radially outwardly from the sidewall 734. A first pair of ports 744, 746 are positioned on a first plane P1, and a second pair 748, 750 on a second plane P2. The planes P1, P2 are parallel but offset along the axis X. The first pair of ports 744, 746 are at [X] degrees to each other, and the second pair of ports 748, 750 are at [X] degrees to each other, the pairs are diametrically opposed.

On the interior of the sidewall there are provided a first and second set of ratchet teeth 754, 756. The teeth extend around the entire inner circumference of the sidewall. The first set of teeth 754 are provided on a further first plane Pla, above the first plane P1 but below the second plane P2. The second set of teeth are provided on a further second plane P2a above the second plane P2. Both sets of teeth are raked in the same direction.

### Dial 704

The dial 704 is shown in FIGS. 16a, 16b, FIG. 18 and FIG. 19. It comprises a generally annular, disc-like body 756 having an outer ring portion 758 connected thereto by a filleted portion 760. The outer ring portion 758 is therefore offset from the body 756 in the direction of the axis X to create an annular recess 762. A cylindrical wall 764 extends in an axial direction surrounding the ring portion 758.

Referring to FIG. 18, provided on a first (upper) side of the body 756 there is provided a radial rib 766. In the centre of the rib 766 there is provided a grip 768. The grip 768 is generally cylindrical having an outer profile with a plurality of ridges 770 to allow a user's hand to grip the dial 704. A circular recess 772 is provided in the centre of the grip 768 having a sidewall 774. An opening 776 is provided in the sidewall. Two bosses 778 extend from the base of the grip 768.

In the centre of the dial 704 there is provided a cylindrical through bore 780.

Referring to FIG. 16a, on a second (under) side of the body 756 there is provided a drive shaft 782. The drive shaft 782 is hollow, cylindrical and in communication with the bore 780. The drive shaft 782 comprises a plurality of semi-cylindrical bosses 784 on the interior side with openings 786 defined therein. The drive shaft 782 comprises a first and second set of teeth 788, 790 on the outer side. Each tooth 792 is generally trapezoid in profile and tapered inwardly in an outward radial direction. Both sets of teeth 788,790 are provided in a circumferentially spaced manner, the first set on a plane T1, the second set on a plane T2. The planes are spaced-apart by a distance d. Referring to FIG. 16b, an annular collar 791 is positioned within the drive shaft 782.

### Reel Sub-Assembly 706

The reel sub-assembly is shown in FIG. 17.

First Washer 708 The first washer 708 is an annular disc-shaped body having a central aperture 794. A plurality of radial slots 796 are formed extending from the aperture 794 outwardly into the washer 708. Between each slot 796 there is provided a through-hole 798.

### First Drum 710

The first drum 710 is a cylindrical body having an outer surface 800 with a circumferential groove 802 formed therein. The body has an inner surface 804 having a plurality of teeth 806 protruding radially inwardly. Each tooth 806 is generally trapezoid in profile and tapered inwardly in an outward radial direction. The teeth are positioned on the inner surface 804 aligned with the groove 802 (offset towards an upper end of the drum).

### First Reel 712

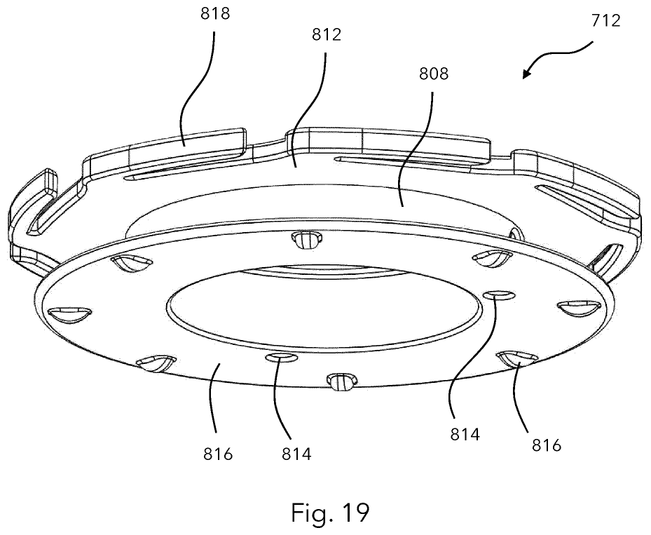

The first reel 712 is shown in FIGS. 17 and 19. The first reel comprises a central, hollow, cylindrical body 808 with a first (lower) flange 810 and a second (upper) flange 812. The flanges 810, 812 extend radially outwardly from the ends of the body 808. The first flange 810 is annular and flat, defining a pair of through-bores 814 and a plurality of spaced-apart feet 816 projecting away from the body 808, proximate the rim. The second flange 812 comprises a plurality of radially outwardly extending resilient ratchet arms 818. Each arm 818 has a base 820 where it attaches to the flange 812 and a circumferentially extending portion 822 terminating in a free end 824. The first reel has a central through bore 826.

### Second Drum 714

The second drum 714 is a cylindrical body having an outer surface 828 with a circumferential groove 830 formed therein. The body has an inner surface 832 having a plurality of teeth 834 protruding radially inwardly. Each tooth 834 is generally trapezoid in profile and tapered inwardly in an outward radial direction. The teeth are positioned on the inner surface 832 offset from the groove 830. The teeth 834 are provided at a first (lower) end of the drum, and the groove 830 at a second (upper) end.

### Second Reel 716

The second reel 716 is identical to the first reel 712.

### Actuation Sub-Assembly 718

The actuation sub-assembly is shown in FIG. 18.

### Dial 704

The dial is described above.

### Washer 720

The washer 720 comprises a hollow shaft portion 836 and an annular flange 838 at a first end. The flange 838 has a central opening 840 smaller than the diameter of the inside of the shaft portion 836.

### Button 722

The button 722 is an annular body having a central aperture 842, two slots 844 either side of the aperture 842 and a notch 846 in its outer perimeter.

### Reel Lead 724

The reel lead 724 comprises a first, cylindrical portion 848 and a second, frustoconical portion 850, tapering inwardly towards a free end giving the reel lead a mushroom-like shape. A central aperture 852 passes through the reel lead 724.

### Top Cover 726

The top cover 726 is generally annular in shape having a central aperture 854 and two fastening apertures 856. The cover 726 has an outer profile with a plurality of ridges 858 to allow a user's hand to grip. A circle-segment cut-out 860 is formed in the reel lead 724.

### Assembly

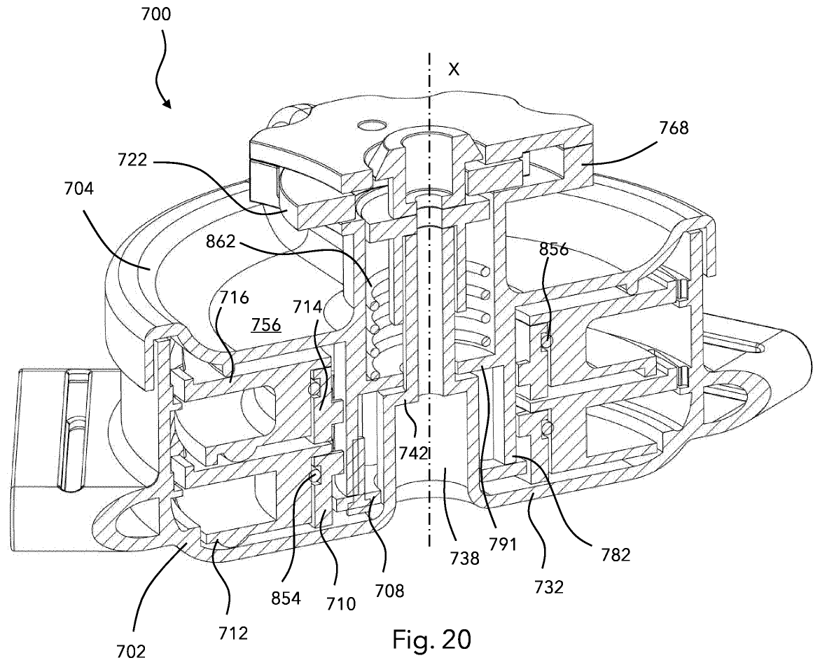

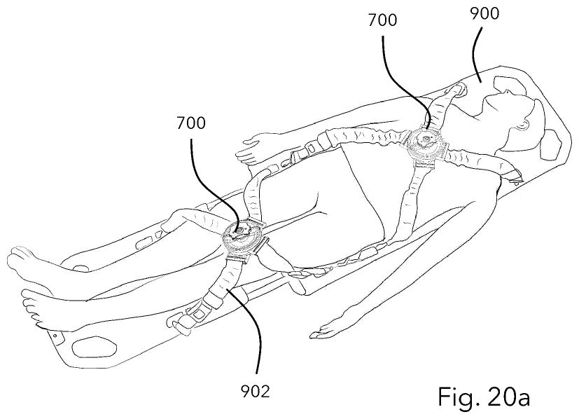

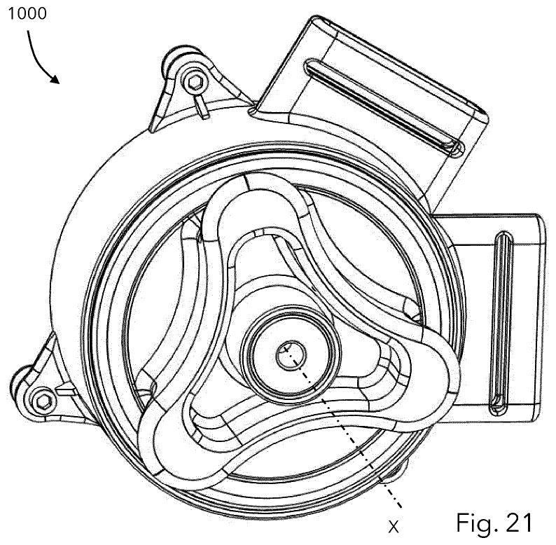

The reel sub-assembly is assembled by stacking the components onto the shaft 782 of the dial 704. Referring to the section view of FIG. 20, the second drum 714 and second reel 716 are assembled together by placing an o-ring 856 in the groove 802 and inserting the drum 714 into the opening 826 of the reel 716. The assembly can then be inserted over the shaft 782 such that the teeth 834 and teeth 792 are engaged.

The first drum 710 and first reel 712 are assembled in the same way with an o-ring 854 and inserted over the shaft 782 such that the teeth 792, 806 are engaged. The first washer 708 is then used to cap the shaft 782 by via fasteners inserted through the openings 798 into the openings 786 in the bosses 784. The washer 708 retains the assembled reels and bosses, although a degree of relative movement of the reels 710, 714 up and down the shaft 782 is possible to engage and disengage the sets of teeth 788, 790, 806, 834 as will be described below.

The casing 702 is assembled by inserting the shaft 736 through the washer 708 and shaft 782 such that the second portion 740 passes through the collar 791.

The actuation sub-assembly is constructed by placing a compression spring 862 into the bore 780 in the dial 704 around the shaft 736. The lower end of the spring 862 contacts the collar 791 as shown in FIG. 20. The washer 720 is inserted into the spring 862 such that it is supported by the end 742 of the second portion 740 of the shaft 736. The button 722 is positioned on the upper surface of the grip 768, the reel lead 724 inserted into the button and the top cover 726. The top cover 726 is secured to the dial 704 with fasteners which pass through the apertures 856, slots 844 and into the bosses 778 to be secured. In this way, the button 842 is trapped and can only move in a single linear direction by a set distance.

A fastener is provided (not shown) which is aligned with the axis X and secures against the lower side of the shoulder 742 on the underside, and the inner side of the reel lead 724. The fastener holds the assembly together.

### Use

The present disclosure is suitable for tensioning a strap. The strap (which may be e.g., inextensible and flexible such as webbing). The strap has a tension member attached to a first end, the tension member being constructed from a flexible material with a high tensile strength such as Kevlar (TM) or a braided metal material and being dimensioned so as to be wound on the reel(s).

The tension members are passed into each of the ports 744, 746, 748, 750 to engage with one of the reels. It will be noted that the ports 744, 746 are level with the upper reel 716, and the ports 748, 750 with the lower reel 712.

The default condition shown in FIG. 20 is the “winding condition”.

Rotation of the dial 704 relative to the casing 702 causes rotation of the reels by engagement of the teeth on the drive shaft (788, 790) with the teeth on the drums (809, 834 respectively). The spring 862 ensures that the dial is in a downward position relative to the housing to ensure such engagement between the teeth. The dial is also locked in the downward axial position by the button 722. Rotation of the reel(s) causes the tension member (being flexible and inextensible) to be drawn into the device. Rotation is made in the clockwise direction about X from above such that the ratchet arms 818 run over the ratchet teeth 754/756. Due to this engagement, reverse rotation of the dial 704 is not permitted (the arms 818 would lock against the teeth).

To release the tension, a combination of movements need to be made. This avoids accidental release. The button 722 is depressed via the opening 776. Depression of the button 722 causes it to move and for the aperture 842 to align with the reel lead 724. The dial 704 can then be lifted via the underside of the grip 768. Because the straps are tensioned, they hold the casing 702 in position. Therefore lifting the grip 768 causes the dial 704 to separate from the casing against the bias of the spring 862.

The first thing to happen is that the teeth 788, 790, 806, 834 disengage. This breaks the rotational load path between the dial and the drums. At this point (the “intermediate position”) the reels cannot rotate as they are locked against the housing by the ratchet. Further lifting of the dial causes the washer 708 to abut the lower (first) drum 710, which lifts the first reel 712, the upper (second) drum 714 and second reel 716. As the reels 712, 716 are lifted in an axial sense, the ratchets are disengaged, allowing the reels 712, 716 to rotate freely about the axis X such that the straps loosen. The reels and drums do not back-drive the dial because the teeth have been disengaged. This is the “unwinding”condition of the assembly.

In this way, pulling the device both “unlocks” the straps and serves to loosen them at the same time, with a single motion. Releasing the dial 704 will reengage both the reels with the ratchet teeth on the housing, and the teeth on the dial shaft with those on the drums.

Referring to FIG. 20a, an application of the present disclosure is shown. In this application, a stretcher 900 has a strapping system 902 incorporating the assembly 700 of the present disclosure. As well as being able to easily tighten the straps to a desired level that will secure, but not harm, the patient, the present disclosure also offers easy and quick release to patient transfer to a bed or gurney.

A further advantage of the assembly 700 in some embodiments is that it can be held in position and tensioned. If the assembly 700 is positioned anywhere but central to the four straps 902, the shorter straps will tension first and then slip as the remaining straps are tensioned. This allows the assembly 700 to be positioned as desired, and to still secure the patient. For example, the assembly 700 may be positioned away from a wound.

### Description of the Fourth Embodiment

A fourth strap tensioning assembly 1000 is shown in FIGS. 21 to 23. It comprises a primary axis X.

### Configuration

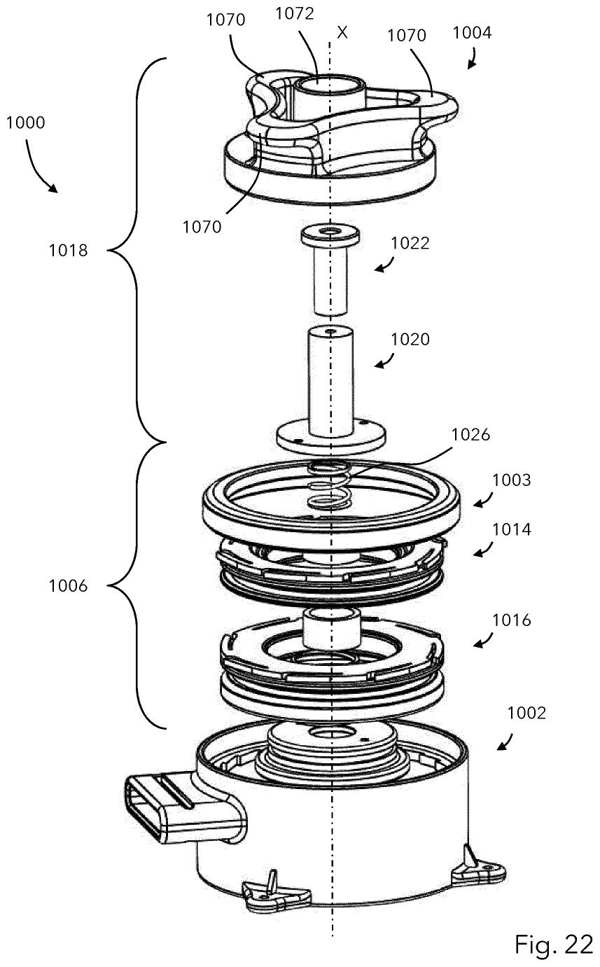

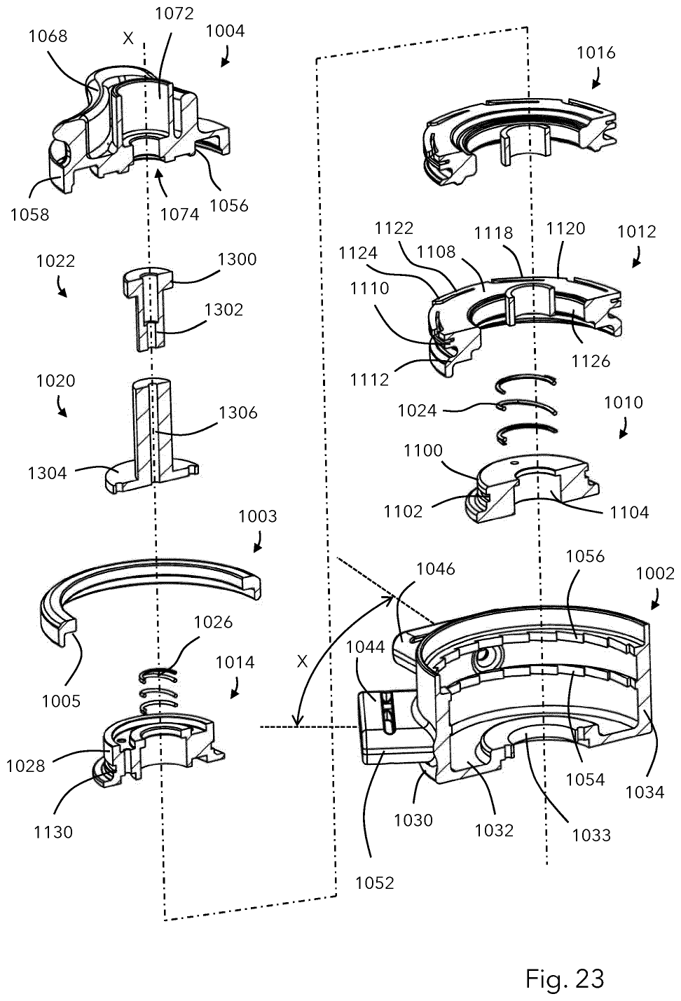

Referring to FIGS. 22 & 23, the assembly comprises:
A casing 1002
A casing ring 1003;
A reel sub-assembly 1006 comprising:
   A first drum 1010;
   A first reel 1012;
   A second drum 1014;
   A second reel 1016;
An actuation sub-assembly 1018 comprising:
   A dial 1004;
   A lower shaft 1020;
   An upper shaft 1022;
   A lower spring 1024; and,
   An upper spring 1026.

### Casing 1002

Referring to FIG. 23, the casing 1002 comprises a cylindrical body 1030 having a closed endwall 1032 and a cylindrical sidewall 1034.

Two ports 1044, 1046 are provided in the sidewall. The ports are generally elongate (in a circumferential direction) and have respective shrouds 1052 extending radially outwardly from the sidewall 1034. The first port 1044 is positioned on a first plane P1, and the second port 1046 on a second plane P2. The planes P1, P2 are parallel but offset along the axis X. The ports 1044, 1046 are at X degrees to each other.

On the interior of the sidewall there are provided a first and second set of ratchet teeth 1054, 1056. The teeth extend around the entire inner circumference of the sidewall. The first set of teeth 1054 are provided on a further first plane Pla, above the first plane Pl but below the second plane P2. The second set of teeth are provided on a further second plane P2a above the second plane P2. Both sets of teeth are raked in the same direction.

On the endwall 1032 there is provided a circular opening 1033.

### Casing Ring 1003

The casing ring 1003 is an annular ring having a shoulder 1005 for receiving the upper edge of the sidewall of the casing 1002.

### First Drum 1010

The first drum 1010 is a cylindrical body having an outer surface 1100 with a circumferential groove 1102 formed therein. A bore 1104 passes through the centre of the drum 1010.

### First Reel 1012

The first reel 1012 comprises a central, hollow, cylindrical body 1108 with a first (lower) flange 1110 and a second (upper) flange 1112. The flanges 1110, 1112 extend radially outwardly from the body 1108. The body 1108 comprises a plurality of radially outwardly extending resilient ratchet arms 1118. Each arm 1118 has a base 1120 where it attaches to the body 1112 and a circumferentially extending portion 1122 terminating in a free end 1124. The first reel has a central through bore 1126.

### Second Drum 1014

The second drum 1014 is a cylindrical body having an outer surface 1028 with a circumferential groove 1130 formed therein.

### Second Reel 1016

The second reel 1016 is similar in form to the first reel 1012.

### Actuation Sub-Assembly 718

The actuation sub-assembly is shown in FIG. 18.

### Dial 1004

The dial 1004 comprises a generally annular, disc-like body 1056 having an outer ring portion 1058.

Provided on a first (upper) side of the body 1056 there is provided a grip 1068. The grip 1068 comprises three lobes 1070 to allow a user's hand to grip the dial 1004. A circular cylindrical sleeve 1072 is provided in the centre of the grip 1068. A central opening 1074 passes all the way through the dial 1004.

### Lower Shaft 1020

The lower shaft 1020 is generally cylindrical defining a flange 1304, and a central bore 1306.

### Upper Shaft 1022

The upper shaft 1022 is generally cylindrical defining a head 1300, and a central bore 1302.

### Lower Spring 1024/Upper Spring 1026

The springs 1024, 1026 are helical compression springs. The lower spring 1024 has a lower spring rate (force per unit compression) than the upper spring 1026.

### Assembly

The lower shaft 1020 is inserted through the opening 1033 in the casing 1002 such that the flange 1034 abuts the underside of the endwall 1032. It is attached to the casing 1002. The lower spring 1024 is positioned over the shaft 1020.

The first drum 1010 and first reel 1012 are assembled with an o-ring (not shown) between them, within the groove 1102. The assembled components are then slid over the shaft 1020 into abutment with the spring 1024.

The second drum 1014 and second reel 1016 are assembled with an o-ring (not shown) between them, within the groove 1130. The assembled components are then slid over the shaft 1020 into abutment with the spring first drum and reel.

The second spring 1026 is then inserted into the sleeve 1072, followed by the upper shaft 1022. The dial 1004 is then positioned in the casing 1002 bringing the upper shaft 1022 and lower shaft 1020 into abutment. A screw (or similar mechanical fastener-not shown) is used to secure the shafts (and the entire assembly) together.

The reels 1012, 1016 are coupled to the dial 1004 such that rotation of the latter causes rotation of the former. The reels 1012, 1016 are coupled to the dial via a pin in a curved track. When the pin reaches the end of the track, it forces the reel to start rotating.

### Use

As with the previous embodiment, tension members are passed into each of the ports 1044, 1046 to engage with a respective one of the reels. It will be noted that the port 1044 is level with the upper reel 1016, and the port 1046 with the lower reel 1012.

Rotation of the dial 1004 relative to the casing 1002 causes rotation of the reels by engagement of the teeth on the drive shaft with the teeth on the drums. Rotation of the reel(s) causes the tension member (being flexible and inextensible) to be drawn into the device. Rotation is made in the clockwise direction about X from above such that the ratchet arms 1118 run over the ratchet teeth 1054/1056. Due to this engagement, reverse rotation of the dial 1004 is not permitted (the arms 1118 would lock against the teeth).

To release the tension, the dial 1004 can be lifted via the underside of the grip 1068. Because the straps are tensioned, they hold the casing 1002 in position.

The assembly also goes through an intermediate condition (where the dial is decoupled from the drums) to an unwinding condition (where the reels are lifted clear of the ratchet teeth on the housing). As the reels 1012, 1016 lift in an axial sense, the ratchets are disengaged, allowing the reels 1012, 1016 to rotate freely about the axis X such that the straps loosen. In this way, pulling the device both “unlocks” the straps and serves to loosen them at the same time, with a single motion. Releasing the dial 1004 will reengage the dial with the drums and the reels 1012, 1016 with the teeth under resilient expansion of the spring 1026.

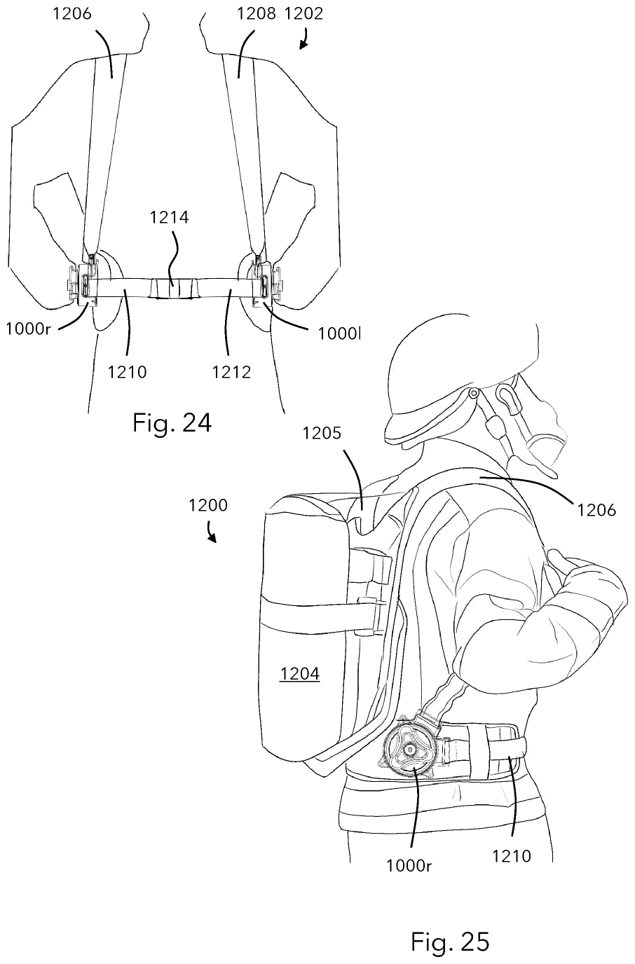

Referring to FIGS. 24 and 25, an application of the present disclosure is shown, In this application, a breathing apparatus (BA) 1200 for a firefighter 1202 is provided, in the style of a backpack. The BA has a gas tank 1204 installed in a carrier 1205. The carrier 1205 has two shoulder straps 1206, 1208 and a waist strap having two parts 1210, 1212 joined by a buckle 1214. The shoulder straps 1206, 1208 are attached to the carrier at the shoulder region, and connected to a pair of respective strap tensioning assemblies 1000r, 1000l at the hips. The respective waist strap parts 1210, 1212 are also connected to the strap tensioning assemblies 1000r, 1000l.

Each of the ends of the straps connected to the strap tensioning assemblies 1000r, 1000l is provided with a tension member for winding onto the reels.

In use, the firefighter 1202 dons the BA (when the straps are loose). The belt buckle 1214 is fastened and the two oppositely (mirror image) assemblies 1000l, 1000r are tightened by rotating the respective dials 1004. This tightens the straps at the shoulders and waist. It will be noted that because of the o-rings positioned between the respective drums and reels, some limited slip is permitted meaning that if e.g. the shoulders tighten to an appropriate level before the belt, the shoulder drum will slip within the reel, whilst the waist drum will continue to tighten. In this way, the system is automatically adjustable to the correct balance of tension.

In one embodiment, the clutch effect provided between the drums and reels is varied between them, such that the shoulders and waist end up at different tensions (for example with the waist tightening to a higher tension/higher slip force than the shoulders). This is particularly relevant for firefighter BA straps because over tensioning at the shoulders can compress the firefighter's suit's insulation, making it less effective.

This may be designed-in by adjusting the size, shape and even materials of the o-rings and respective grooves. It should also be noted that the clutch may be provided by other means than a slip ring.

### Description of the Fifth Embodiment

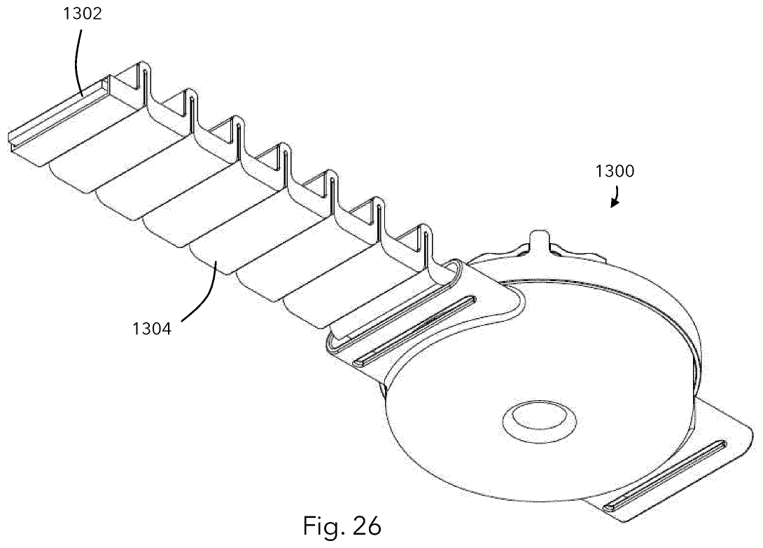

FIG. 26 shows an embodiment where an apparatus 1300 (similar to the apparatus 1000) where a section of strap/webbing 1302 is provided with a tension member fed into the apparatus 1300. Pulling the tension member into the apparatus 1300 results in the webbing being gathered, and a flexible, resilient sleeve 1304 is provided in order to control the gathering of the webbing 1302.

### Description of the Sixth Embodiment

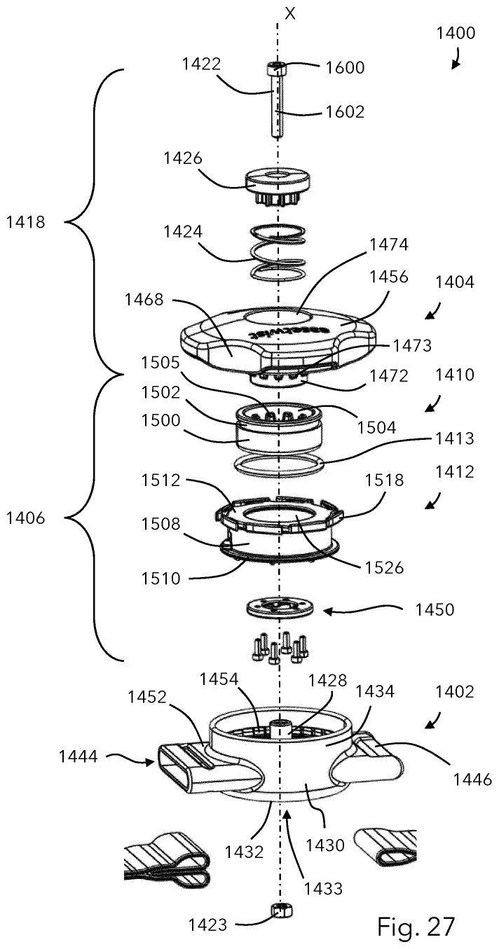

A sixth strap tensioning assembly 1400 is shown in FIG. 27. It comprises a primary axis X.

### Configuration

Referring to FIG. 27, the assembly comprises:
A casing 1402
A reel sub-assembly 1406 comprising:
   A drum 1410;
   A reel 1412;
An actuation sub-assembly 1418 comprising:
   A dial 1404;
   A screw 1422;
   A spring 1424;
   A spring bearing plate 1450; and,
   A cap 1426.

### Casing 1002

Referring to FIG. 27, the casing 1402 comprises a cylindrical body 1430 having a closed endwall 1432 and a cylindrical sidewall 1434.

A port 1444 is provided in the sidewall. The port is generally elongate (in a circumferential direction) and has a shroud 1452 extending radially outwardly from the sidewall 1434. A strap fastening formation in the form of a bar 1446 is provided diametrically opposed to the port 1444.

On the interior of the sidewall there are provided a set of ratchet teeth 1454. The teeth extend around the entire inner circumference of the sidewall.

On the endwall 1432 there is provided a circular opening 1433 with a shaft 1428 concentric therewith and extending therefrom.

### Drum 1410

The drum 1410 is a cylindrical body having an outer surface 1500 with a circumferential groove 1502 formed therein. A bore 1504 passes through the centre of the drum 1410. Several locking teeth 1505 are defined on the inside of the bore 1504 for part of its depth.

### Reel 1412

The reel 1412 comprises a central, hollow, cylindrical body 1508 with a first (lower) flange 1510 and a second (upper) flange 1512. The flanges 1510, 1512 extend radially outwardly from the body 1408. The body 1408 comprises a plurality of radially outwardly extending resilient ratchet arms 1518. Each arm 1518 has a base where it attaches to the body and a circumferentially extending portion terminating in a free end. The first reel has a central through bore 1526.

### Actuation Sub-Assembly 1418

### Dial 1404

The dial 1404 comprises a generally annular, disc-like body 1456.

Provided on the outer edge of the body 1456 there is provided a grip 1468. The grip 1468. A circular cylindrical shaft 1472 is provided in the centre of the dial 1404. A central opening 1474 passes all the way through the dial 1404. Locking teeth 1473 are provided on the outer surface of the shaft 1472.

### Screw 1422

The screw 1422 is generally cylindrical defining a head 1600, and a threaded shaft 1602.

### Spring 1426

The spring 1426 is a helical compression spring.

### Spring Bearing Plate 1450

The spring bearing plate 1450 is annular in shape with a plurality of openings.

### Assembly

The drum 1410 and reel 1412 are assembled with the drum 1410 within the reel 1412. An elastomeric o-ring 1413 is positioned between the drum and reel as with previous embodiments, and is configured to provide a torque limiting function by allowing one or both elements to slip relative thereto, once static friction has been overcome.

The dial 1404 is then positioned on top of the assembly with the shaft 1472 penetrating the drum 1410. The spring 1424 is inserted into the opening 1474 and the cap 1426 used to seal it. The spring bearing plate 1450 is secured to the underside of the arrangement to capture the spring 1424. In this way, the cap 1426 can be pushed into the arrangement to compress the spring 1424.

This subassembly is then threaded onto the shaft 1428 such that the cap 1426 abuts the top of the shaft 1428. The screw 1422 is inserted through the entire assembly (through the shaft 1428) to protrude from the underside, where it is secured with a nut 1423. The shaft 1428 and cap 1426 are thereby held together.

### Use

As with the previous embodiment, a tension members is passed into the port 1444, to engage with the reel.

Rotation of the dial 1404 relative to the casing 1402 causes rotation of the reel by engagement of the teeth on the drive shaft with the teeth on the drums. Rotation of the reel(s) causes the tension member (being flexible and inextensible) to be drawn into the device. Rotation is made in the clockwise direction about X from above such that the ratchet arms 1518 run over the ratchet teeth 1454. Due to this engagement, reverse rotation of the dial 1404 is not permitted (the arms 1518 would lock against the teeth).

To release the tension, the dial 1404 can be lifted relative to the casing 1402. Because the cap 1426 is secured to the casing, it can be help with e.g. the user's thumb and the dial 1404 pulled. That said, because the straps are typically tensioned, they hold the casing 1402 in position. Therefore lifting the dial 1404 causes it to separate from the casing against the bias of the spring 1424.

As the dial 1404 lifts, the intermediate condition is reached where the teeth 1473 lift clear of the teeth 1505. This decouples the dial and drum. Further lifting causes the washer 1450 to lift the drum and reel such that the reel is disengaged from the housing ratchet teeth (to the unwinding condition). As the reel lifts in an axial sense, the ratchets are disengaged, allowing the reel to rotate freely about the axis X such that the straps loosen. In this way, pulling the device both “unlocks” the straps and serves to loosen them at the same time, with a single motion. Releasing the dial 1404 will reengage the reel with the teeth under resilient expansion of the spring 1424.

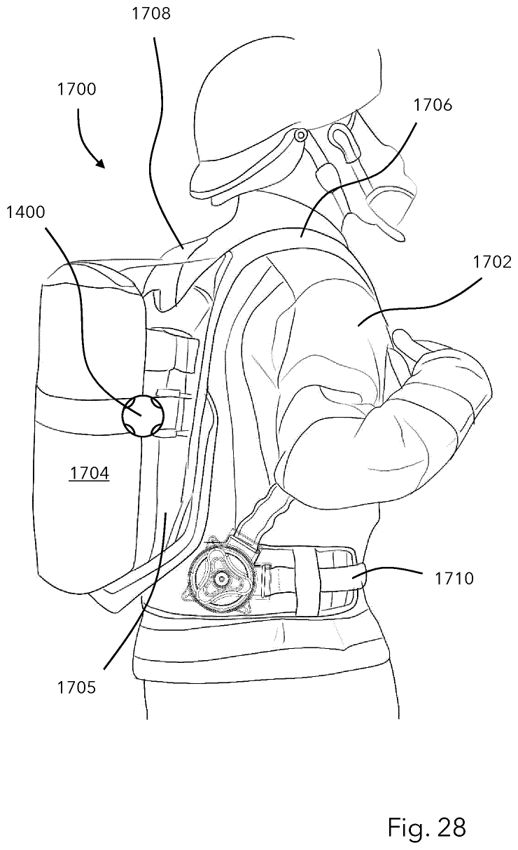

Referring to FIGS. 28 & 29, an application of the present disclosure is shown.

In this application, a breathing apparatus (BA) 1700 for a firefighter 1702 is provided, in the style of a backpack. The BA has a gas tank 1704 installed in a carrier 1705. The carrier 1705 has two shoulder straps 1706, 1708 and a waist strap 1710. The tank is secured to the carrier 1705 with a strap 1711 tensioned by the device 1400.

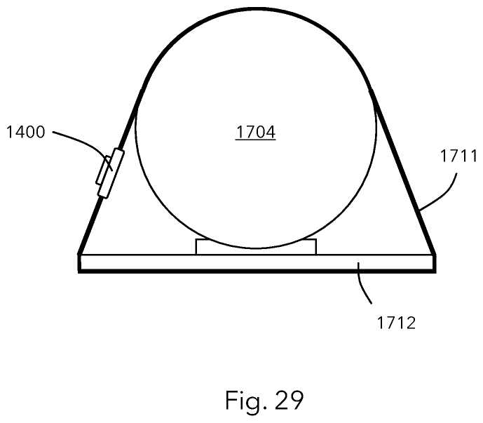

Referring to FIG. 29, it can be seen that the carrier frame 1712 is placed in three-point bending by the tension of the strap 1711. It is therefore important that the amount of tension in the strap 1711 is controlled. If it is too low, the tank 1704 will not be properly secured. If it is too high, the tension may damage the frame 1412 (which is primarily designed to be light). Therefore there is a tension window to be achieved. The present disclosure enables this by providing the torque limiting clutch arrangement described herein. The present disclosure also facilitates fast release of the arrangement for tank replacement.

The present disclosure provides tensioning to the correct degree whilst allowing the strap 1711 to be a variety of lengths-for example if a larger or multiple tanks are attached.

In one embodiment, the entire assembly 1400 is constructed from metal components for increased strength. Fire resistant materials (plastics/metals) may also be used for certain applications.

### Variations

Instead of the members 504a-504d being deformable, they may be non-deformable and resiliently biased into the rest position of FIGS. 11a o 11c, e.g. by a resilient material or member.

Instead of individual flexible members, there may be a single flexible sleeve formed in the shape of P1, which is constructed from an elastically deformable material.

Other types of backpack/back mounted equipment or restraints may be secured according to the fourth embodiment. It will also be noted that an apparatus according to the disclosure may be provided in the centre of the belt.

In many embodiments, the unit according to the disclosure is sealed—i.e., protected from ingress of foreign materials. The inherent design of the system with the dial/cover provides some degree of ingress protection, for example in the BA application where ingress of soot is a concern.

Any of the embodiments described herein may be used for a range of applications, including occupant restraints, restraints for items, backpacks, rucksacks, diving/scuba equipment, safety straps, car safety nets for motorsport and so on.

What is claimed is:

1-60. (canceled)

61. A strap tensioning assembly for use with a first tension member, the strap tensioning assembly comprising:
a casing;
a reel configured to wind the first tension member into the casing upon rotation thereof;
a dial connected to the reel such that rotation of the dial rotates the reel;
a first torque limiting clutch between the reel and the dial, such that a tension in the first tension member caused by winding the dial is limited; and,
a one-way clutch between the reel and the casing, such that relative rotation of the reel and the casing is enabled in a first direction but prohibited in a second, opposite, direction;
wherein the dial is moveable along its axis of rotation such that movement of the dial away from the casing causes the one-way clutch to disengage to allow rotation of the reel in the second direction.

62. The strap tensioning assembly according to claim 61, comprising a dial locking mechanism configured to inhibit movement of the dial away from the casing.

63. The strap tensioning assembly according to claim 62, wherein the dial locking mechanism comprises a button that requires depression to unlock the dial.

64. The strap tensioning assembly according to claim 61, wherein the dial is biased towards the casing.

65. The strap tensioning assembly according to claim 61, wherein the first torque limiting clutch comprises a deformable friction member between the reel and the dial.

66. The strap tensioning assembly according to claim 65, wherein the deformable friction member is an elastomeric ring in contact with both the reel and the dial.

67. The strap tensioning assembly according to claim 61, wherein the one-way clutch comprises a ratchet.

68. The strap tensioning assembly according to claim 61, comprising a positive clutch between the dial and the reel, such that movement of the dial away from the casing disengages the positive clutch to decouple the dial from the reel.

69. The strap tensioning assembly according to claim 68, wherein the positive clutch comprises two interlocking sets of teeth on the dial and the reel respectively.

70. The strap tensioning assembly according to claim 69, wherein movement of the dial away from the casing causes the positive clutch to disengage before the one-way clutch.

71. The strap tensioning assembly according to claim 61, wherein the reel is a first reel, the assembly comprising:
a second reel configured to wind a second tension member into the casing upon rotation thereof;
the dial connected to the first and second reels such that rotation of the dial rotates the first and second reels.

72. The strap tensioning assembly according to claim 71, comprising a second torque limiting clutch between the second reel and the dial, such that a tension in the second tension member is limited.

73. The strap tensioning assembly according to claim 72, wherein the first torque limiting clutch and second torque limiting clutch are configured to slip at different tensions in the first and second tension members respectively.

74. The strap tensioning assembly according to claim 71, wherein the second reel has a direct drive from the dial with no torque limitation.

75. The strap tensioning assembly according to claim 72, wherein the first torque limiting clutch and the second torque limiting clutch are defined between a hub member and each reel, the hub member being driven by the dial.

76. The strap tensioning assembly according to claim 75, wherein the first torque limiting clutch and the second torque limiting clutch each comprises a deformable friction member between each hub and each respective reel.

77. The strap tensioning assembly according to claim 76, wherein the deformable friction member is an elastomeric ring in contact with both the hub and each respective reel.

78. The strap tensioning assembly according to claim 71, comprising a further one-way clutch between the second reel and the casing, such that relative rotation of the second reel and the casing is enabled in the first direction but prohibited in the second, opposite, direction.

79. An assembly of a mounting plate and an item to be mounted, the assembly comprising a strap holding the item to be mounted against the mounting plate, wherein tension in the strap causes a bending moment to be applied to the mounting plate, and wherein the assembly comprises a strap tensioning assembly comprising:
a casing
a reel configured to wind a first tension member into the casing upon rotation thereof;
a dial connected to the reel such that rotation of the dial rotates the reel;
a torque limiting clutch between the reel and the dial, such that a tension in the first tension member caused by winding the dial is limited; and,
a one-way clutch between the reel and the casing, such that relative rotation of the reel and the casing is enabled in a first direction but prohibited in a second, opposite, direction;
wherein the dial is moveable along its axis of rotation such that movement of the dial away from the casing causes the one-way clutch to disengage to allow rotation of the reel in the second direction.

80. The assembly according to claim 79, wherein the item to be mounted is a tank of a breathing apparatus to be secured to a user's back.
